(19) United States
(12) Patent Application Publication
(10) Pub. No.: US 2022/0307366 A1
(43) Pub. Date: Sep. 29, 2022

(54) AUTOMATED OFFSET WELL ANALYSIS

(71) Applicant: Landmark Graphics Corporation, Houston, TX (US)

(72) Inventors: Anandhan M. Selveindran, Houston, TX (US); Avinash Wesley, New Caney, TX (US); Nitish Damodar Chaudhari, Houston, TX (US); Helmut Andres Pirela, Houston, TX (US)

(21) Appl. No.: 17/594,842

(22) PCT Filed: Jan. 16, 2020
(86) PCT No.: PCT/US2020/013892

§ 371 Date: Nov. 1, 2021

Related U.S. Application Data
(60) Provisional application No. 62/890,998, filed on Aug. 23, 2019.

(51) Int. Cl. E21B 47/00

(52) U.S. Cl. CPC E21B 47/00; E21B 2200/22; E21B 2200/20

(57) ABSTRACT

An automated offset well analytics engine generates offset well rankings for a prospect well. The engine aggregates data for offset wells and the prospect wells is across multiple disparate data sources corresponding to a user-specified scope. The engine generates features comparing the offset wells to the prospect well are using a combination of machine-learning based models and risk analysis. Offset wells are ranked by feature and further ranked across features using a weighted feature ranking map. Feature weights are iteratively trained using a reinforcement learning model in a feedback loops with a well expert. A prospect well casing schema and bottom hole assembly is designed using automatically generated offset well rankings.

### BACKGROUND

The disclosure generally relates to the field of well design and to artificial intelligence.

Offset well analysis is a workflow involving teams of geologists, drilling engineers, logistics and supply chain, maintenance, and sometimes production and reservoir engineers. The workflow involves collecting surface and subsurface geological data and narrowing down a set of candidate offset wells using similarity measures between offset wells and a prospect well and features of the offset wells. The offset wells are used to inform a well planning design for the prospect well. This entire process, depending on the size and characteristics of the field, can take a few days to several months.

### BRIEF DESCRIPTION OF THE DRAWINGS

FIG. 1 depicts a system diagram for an automated offset well ranking workflow implementation.

FIG. 2 depicts a system diagram for an offset well feature generator.

FIG. 3 is a flowchart of example operations for generating an offset well ranking.

FIG. 4 is a flowchart of example operations for generating a prospect well casing schema.

FIG. 5 depicts an example computer system with an automated offset well analytics engine.

FIG. 6 depicts a system diagram of a wireline system with an automated offset well analytics engine.

FIG. 7 depicts a system diagram of a drilling rig system with an automated offset well analytics engine.

### DESCRIPTION

The description that follows includes example systems, methods, techniques, and program flows that embody aspects of the disclosure. However, it is understood that this disclosure may be practiced without these specific details. For instance, this disclosure refers to ranking-based offset well risk analytics in illustrative examples. Aspects of this disclosure can be instead applied to hazard detection in deployed well systems. In other instances, well-known instruction instances, protocols, structures and techniques have not been shown in detail in order not to obfuscate the description.

Overview

Choosing a template offset well in the workflow of offset well analysis depends on a broad range of well features from disparate sources. Each feature is a measure of similarity between a template offset well and a prospect offset well. Aggregating features for each desired comparison of the prospect well and candidate wells is an exhaustive process that wastes operator resources to investigate and design the prospect offset well from scratch. The presently developed workflow automates many of the steps involved in offset well analysis including aggregating well features, computing domain-specific similarity analytics for each feature, ranking candidate offset wells for each feature, combining feature rankings with a weighted map, and designing prospect well drilling operations based on the ranked candidate offset wells. This workflow is customizable and enables an expert user to create custom features and weights to translate the aggregated analytics to field-specific applications. Moreover, the workflow further comprises a fully integrated hazard database associated with potential well designs.

Metrics for candidate template wells including well distance, well age, water depth, well type, trajectory similarity, lithology similarity, pore/fracture pressure similarity, non-productive time (NPT), cost per foot, time to drill a specified distance, and user generated custom metrics are implemented in the workflow. Each metric is automatically computed using a combination of machine-learning based models and metric formulas. The computed metrics are aggregated into a weighted ranking criterion, where the final rank of a candidate offset well is a weighted combination of the rankings according to each metric.

The workflow, as it receives offset well data for the above metrics, maintains a risk registry that associates features for each template offset well with potential hazards. The risk registry comprises a classification model that receives data corresponding to NPT events and other offset well features including well cost per foot and time to drill a specified distance, and outputs risk analytics including a hazard type, a severity metric (indicating a level of risk) for that hazard type, and a set of features corresponding to that hazard type for the offset well. These risk analytics can be provided to an expert and used to inform weights in the weighted average offset well rankings.

Weight training for the weighted offset well ranking occurs as a reinforcement learning (RL) feedback loop between an RL model and a field expert who evaluates incoming rankings. The training process occurs as two phases. In a first phase, the expert initializes weights using domain knowledge and, using the weights, the RL model outputs a ranking of candidate offset wells to the expert. The expert responds to the candidate ranking with a “yes” or “no” indicator that tells the RL model whether the ranking is accurate (or, in some embodiments, a number on a numerical scale that indicates ranking quality). The expert can then choose to update the weights based on the quality of the rankings. Thus, the expert provides a sequence of weights and corresponding quality indicators that informs the RL model. In a second phase, the RL model trains on the sequence of weights and indicators provided by the expert and generates new sequences of weights. The expert continues to evaluate each sequence of weights, and the RL model continues to automatically generate the new sequences of weights in response. Any hybrid combination of phases 1 and 2 can further be implemented. Weight initialization and updates by both the expert and the RL model can be informed by features and severity metrics from the risk registry for each candidate offset well in the rankings. For example, a set of features identified as risk-averse for a candidate offset well can have lower weights on expert initialization/updates or can have smaller weights in a cost function for the RL model learning objective function.

Once the RL model has been sufficiently trained using the expert/RL model feedback loop, the RL model presents a finalized candidate template well ranking to the expert. The expert can design a casing schema for the prospect well using the candidate template well ranking. This casing schema can be broad and further refined by successive offset well rankings using offset well data specific to well sections.

Example Illustrations

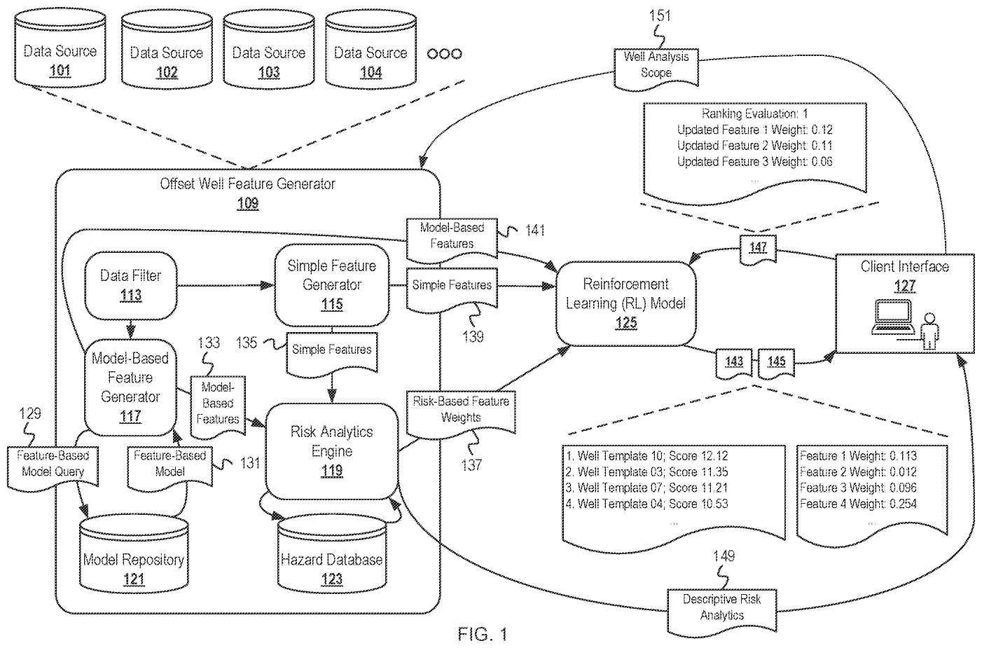

FIG. 1 depicts a system diagram for an automated offset well ranking workflow implementation. The system diagram depicts an offset well feature generator 109, data sources 101-104, a reinforcement learning (RL) model 125, and a client interface 127. Data flows from the data sources 101-104 to the offset well feature generator 109 which outputs features to the RL model 125. In addition, data is communicated between the RL model 125 and the client interface 127 as well as between the client interface 127 and the offset well feature generator 109.

The data sources 101-104 comprise disparate data sources that track data corresponding to each computed feature for a prospect well and candidate offset wells. The data sources can be lithology databases, well trajectory databases, offset well event logs, oil field blueprints, oil field specification databases, etc. and the raw data can be measured by sensors in logging-while-drilling operations or other equivalent drilling system measurement sensors, satellite global positioning systems, etc.

The offset well feature generator 109 receives template offset well data from data sources 101-104. The offset well feature generator 109 comprises several components that generate features and risk analytics related to the template offset well data. A data filter 113 receives the template offset well data and separates the data into model-based feature data and simple feature data. The data filter 113 further preprocesses the model-based feature data into a data format that is compatible with each respective model and forwards the formatted model-based feature data to a model-based feature generator 117. Since the offset well data from data sources 101-104 can come in different formats, the data filter 113 can comprise a data normalizer for data corresponding to each type of feature. The model-based feature generator 117 queries a model repository 121 with a feature-based model query 129 for each feature in the formatted model-based feature data. The model repository 121 retrieves a corresponding feature-based model 131. The model-based feature generator 117 receives the feature-based model 131 and runs it using the corresponding formatted model-based feature data. The feature-based model 131 outputs model-based features 133 to a risk analytics engine 119 and outputs model-based features 141 to the RL model 125. The model-based features 141 comprise all the features generated by the feature-based model 131, whereas the model-based features 133 comprise features that are specific to risk analytics, for example non-productive time (NPT) data, cost data, and drilling time data.

The data filter 113 sends the simple feature data to a simple feature generator 115. The simple feature generator 115 preprocesses the simple feature data, runs simple computations on the processed simple feature data, and outputs simple features 135 to the risk analytics engine 119 and outputs simple features 139 to the RL model 125. As above, the simple features 135 can be a subset of the simple features 139 specific to risk analytics. The risk analytics engine 119 retrieves hazards and respective hazard severity weights indicating levels of risk corresponding to the simple features 135 and model-based features 133 by querying a hazard database 123. Using the hazards and respective hazard severity weights, the risk analytics engine 119 generates risk-based feature weights 137 and descriptive risk analytics 149 which it sends to the RL model 125 and the client interface 127, respectively. Upon receipt of the features 139 and 141, and the feature weights 137, the RL model 125 generates a template offset well rankings 143 and feature weights 145 to send to the client interface 127. The client interface 127 returns a scored ranking evaluation and updated feature weights 147 to the RL model 125.

The model repository 121 can contain various similarity matching models, dynamic programming models, image classification models, natural language processing (NLP) models, etc. that are configured to take as input various types of offset well features. Each model is pretrained on offset well data that can have varying scopes such as a global scope, a localized scope corresponding to a well region, a set of similar oil fields, etc. Consequently, the models can have varying generalization error with respect to the offset well data which can be used to inform their initial feature weights 145 as determined by the RL model 125. The models stored in model repository 121 have an architecture that ensures the features they compute are informative measures for template offset wells, as described variously below. Model scope as well as scope of the input data for candidate offset wells can be specified by a well analysis scope 151 received by the offset well feature generator 109 from the client interface 127.

The RL model 125 is in a communicative loop with the client interface 127. The RL model sends candidate offset well rankings 143 and feature weights 145 to the client interface and, based on these inputs and input to the client interface 127, returns a ranking evaluation and updated feature weights 147. The RL model 125 models an agent and a set of states and tries to predict a sequence of actions for the agent through the set of states based on a cumulative reward function. In this context, the agent is modeling an expert interacting with the client interface 127, the set of states is the space of possible candidate offset well rankings, and the action is an update to the feature weights. The cumulative reward function is predicted using ranking quality feedback as depicted by the scored ranking evaluation and updated feature weights 147. As part of its' training process, the RL model maintains an internal policy map that assigns a probability to each action/state pair that indicates the likelihood of a particular action given a current state. Embodiments can use any of a variety of reinforcement learning models such as Q learning, temporal difference methods, Monte Carlo methods, etc. The candidate offset well rankings generated by RL model 125 are a predetermined function of the feature weights and the features for candidate offset wells. For example, if the feature weights are w₁, . . . , wₖ and the features for a candidate offset well are f₁, . . . , fₓ then the candidate well can be assigned a score w₁f₁+w₂f₂+ . . . +wₖfₖ. Candidate wells can be ranked according to their scores where a higher score indicates a better fit for use in designing the prospect well and thus a higher rank. The features can be normalized to all be within a certain range of values (e.g. between 0 and 1).

Although not depicted in FIG. 1, the client interface 127 can specify custom features to be computed by offset well feature generator 109. These custom features can supplement existing features by computing alternative statistics, combining multiple features so that the custom feature is more descriptive, etc. For example, a feature can comprise an average change in pore/fracture pressure across each layer in the well formation. The offset well feature generator 109 can be configured to receive templates for custom features that are a function of already computed features, and to compute the custom features. The offset well feature generator 109 forwards any custom features to RL model 125 and these custom features are used in the weighted feature rankings during the feedback loop between RL model 125 and client interface 127.

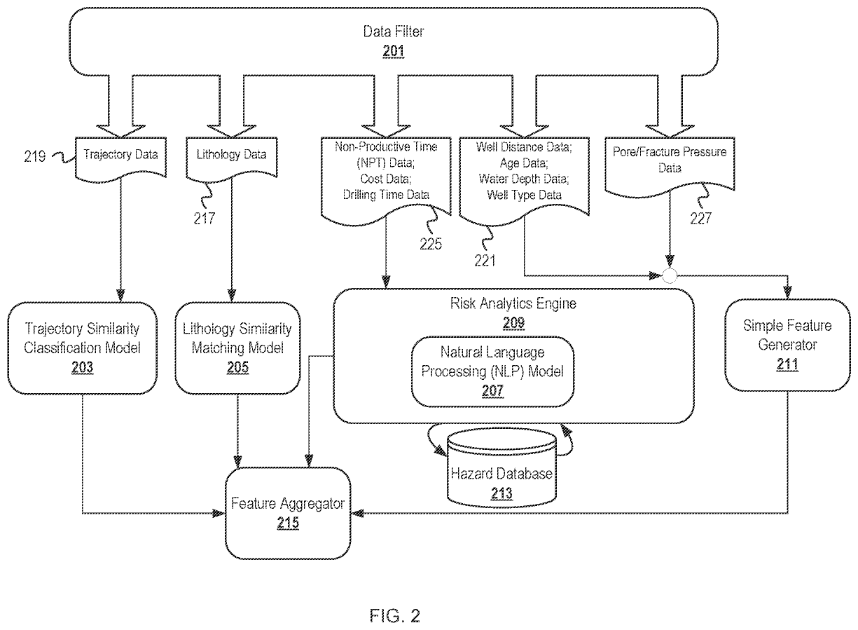

FIG. 2 depicts a system diagram of an offset well feature generator for a prospect well and offset wells. A data filter 201 receives candidate offset well data from disparate data sources as described variously above. The data filter 201 separates incoming data into several inputs to various feature models: lithology data 217 that feeds into lithology similarity matching model 205; trajectory data 219 that feeds into trajectory similarity classification model 203; well distance data, age data, water depth data, well type data 221 and pore/fracture pressure data that feed into simple feature generator 211; and non-productive time (NPT) data, cost data, and drilling time data 225 that feeds into risk analytics engine 209. The risk analytics engine 209 comprises an NLP model 207 and is communicatively coupled to a hazard database 213. A feature aggregator 215 receives the features generated by models 203 and 205, risk analytics engine 209, and simple feature generator 211.

The lithology data 217 comprises lithology sequences of rock types corresponding to the prospect well and candidate offset wells. An example sequence of rock types could be “sandstone 1, shale 1, sandstone 2, thin shale 1, massive sandstone, coal, shale 3, dolo-sandstone 1.” In this example, the number after a rock type indicates a particular sub-type of that rock type. The lithology similarity matching model 205 can comprise any sequence matching algorithm that identifies how close the lithology sequence for the prospect well is to the lithology sequences of the candidate offset wells. For example, a Word2vec model (using a pre-trained shallow neural network) can be used to embed the lithology sequences into Euclidean space and the Euclidean distance can be used as a similarity metric, or the Levenshtein (“edit”) distance applied to lithology sequences can be used. The lithology matching model 205 may be sequence matching algorithm that calculates two distance metrics—a sequence matching metric that counts sequence deletions and sequence insertions as having value one and sums the values of all deletions and insertions to get from one sequence to another, and a depth metric that measures the difference in depth (i.e. length) of each sequence to the prospect lithology sequence. The candidate offset wells are ranked first on sequence matching distance and second (in the case of equal sequence matching difference) on depth distance. A single metric can be aggregated from the sequence matching metric and the depth metric by normalizing the sequence matching metric to be an integer valued between 0 and n for some maximal sequence distance n, normalizing the depth metric to be between 0 and 1, and summing the two metrics. The sequence matching model used by lithology similarity matching model 205 can be chosen based on the complexity of the lithology sequences. Once a similarity metric has been computed, the lithology similarity matching model 205 sends the ranked candidate offset wells and corresponding lithology similarity metric to similarity feature aggregator 215.

The trajectory data 219 comprises depth trajectory plots (i.e. plots of depth versus horizontal displacement) for the prospect well and the candidate offset wells. The trajectory plots can be evaluated based on three parameters—dogleg severity, inclination, and azimuth. Dogleg severity measures how much the direction of the well changes by depth, typically measured in two-dimensional degrees (i.e. angle with respect to the horizontal plane) per 100 feet. Inclination measures the angle with respect to the horizontal plane in two-dimensional degrees. Azimuth measures the angle of the well trajectory in the horizontal plane with respect to a reference compass direction, typically true or magnetic north. The trajectory similarity classification model 203 comprises a classification component that is trained on well trajectory data for each of the above three parameters to classify a well trajectory shape. The classes of well trajectory shapes include “J”, “L”, “S”, “Vertical,” and “Horizontal.” An embodiment may use a long short-term memory (LSTM) neural network to do this classification. LSTM networks include internal LSTM layers that have can “forget” internal parameters and also have “skip” connections that connect far apart layers. This means that for the purposes of classifying a sequence of values such as a well trajectory, the LSTM network tracks long and short-term behavior of the well trajectories. The LSTM network classifies each well trajectory from the prospect and candidate offset wells and outputs a probability map of well trajectory shapes for each well trajectory. A probability map means a set of probabilities (that sum to one) indicating how likely a well trajectory is to correspond to each well shape. A similarity metric can be extracted based on the probability map using any standard metric between the probability map of offset wells and the probability map of the prospect well. Alternatively or in addition, the trajectory similarity classification model 203 can use trained convolutional neural networks (CNNs) for image recognition to generate similarity metrics between well trajectories. The CNNs can be trained on well trajectory image data for a specific well shape (using pre-classified well trajectory training data) or can be trained across multiple well shapes. Thus, the LSTM network can output a most likely well trajectory shape and can retrieve a CNN corresponding to that well trajectory shape to generate the similarity metric.

The NPT data contained in data block 225 comprises descriptive event logs corresponding to subsurface and surface well events only for candidate offset wells (the prospect well has no operational data). External (surface) well events such as weather events and rig/equipment events are excluded from analysis by risk analytics engine 209. Subsurface events such as stuck pipes, lost circulation, formation fluid influx, etc. are retained as containing possible risk indicators for the prospect well. The NLP model 207 parses NPT data contained in event logs to classify events based on expert created hazard categories types. The NLP model 207 is pretrained on event logs classified by hazard category such as those contained in the hazard database 213. In some embodiments, the NLP model 207 can be further trained on precursor hazard events to establish a chain of events that lead to certain hazard categories. Consequently, the NLP model 207 can detect potential hazards across multiple event logs contained in the NPT data. Detected hazards in candidate offset wells are correlated with various deployment parameters including hole section, lithology, bit type/bottom hole assembly, hook load, weight on bit, drilling bit RPM, and depth. Hazards can further be detected by well cost per foot and time to drill a specified distance (e.g., 10,000 feet). Risk analytics generated by risk analytics engine 209 for candidate offset wells may be sent to a user interface for further analysis by an expert when implementing drill design. In some embodiments, the risk analytics engine 209 receives rankings of candidate offset wells and updates/prioritizes the risk analytics based on this ranking. Conversely, the risk analytics engine 209 can generate risk metrics associated with each candidate offset well based on the detected hazards and hazard severity. These risk metrics can inform weights for features such as NPT fraction, cost per foot, and time to drill a specified distance associated with high risk metrics/levels of risk.

The risk analytics engine 209 can further compute the features NPT fraction, cost per foot, and time to drill 10,000 feet. NPT fraction is computed by tracking non-productive time as a fraction of total well deployment time using event logs extracted from the NPT data (and further interpreted by the NLP model 207). The risk analytics engine 209 sends all computed features to the feature aggregator 215.

The simple feature generator 211 receives geological features such as well distance data, age data, water depth data, well type data 221, and pore/fracture pressure data 227. These features are all computed using standard metric formulas and can be implemented in any of the models 203 and 205 and risk analytics engine 209. For example, well distance can be computed using Vicenty's (great circle) formula on global positioning system data for the offset wells and prospect well; offset wells can be sorted by age where the age is in a day/month/year and further sorted by water depth and well type. Although not depicted in FIG. 2, the data filter 201 can impose thresholds on well distance, well age, well water data, and well type that preclude offset wells from analysis.

The simple feature generator 211 can compute a similarity feature for the pore/fracture pressure data by ordering the pore and fracture pressures by true depth and then computing a Euclidean distance (in the space of pressures) between prospect pressures and offset well pressures. In some embodiments, the lithology data 217 and pore/fracture pressure data 227 are combined into a single geological measure comprising a sequence of lithology/pressure pairs. A sequence learning neural network (as described above) can be used to detect similarity between the geological measure for the prospect well and candidate offset wells. This similarity measure can be forwarded to feature aggregator 215.

The trajectory similarity measure and the geological similarity measure can be further refined using a RL training loop. For example, a RL model can take as input the trajectory similarity measure and an expert evaluation of quality for the trajectory similarity measure and can update the trajectory similarity measure based on expert feedback. The RL model can learn from expert feedback on trajectory similarity measures to improve quality, as described above with reference to the RL model 125 and client interface 127 in FIG. 1. In some embodiments, the error in the trajectory similarity measure can be further backpropagated through the sequence matching neural network used to determine the trajectory similarity measure and the sequence matching neural network can update its' internal parameters accordingly. The RL model and the sequence matching neural network can thus be trained simultaneously. A similar training methodology can be implemented using a separate RL model on the sequence learning neural network implemented for the geological similarity measure.

Any of the models, feature generators, or risk analysis engines described herein can be implemented in a cloud-based infrastructure (“cloud”). The cloud can store multiple versions of each model type corresponding to multiple scopes of offset wells. With reference to FIG. 1, the offset well similarity feature generator 109 can efficiently query the cloud with a query that specifies an offset well scope, model type, and model input and the cloud can run a model of the specified offset well scope and model type on the model input to generate a feature. Any model implemented in the cloud can be optimized for cloud computing. This optimization can be specific to the model type. For example, a CNN can parallelize computations of internal node outputs using the layer-based internal architecture.

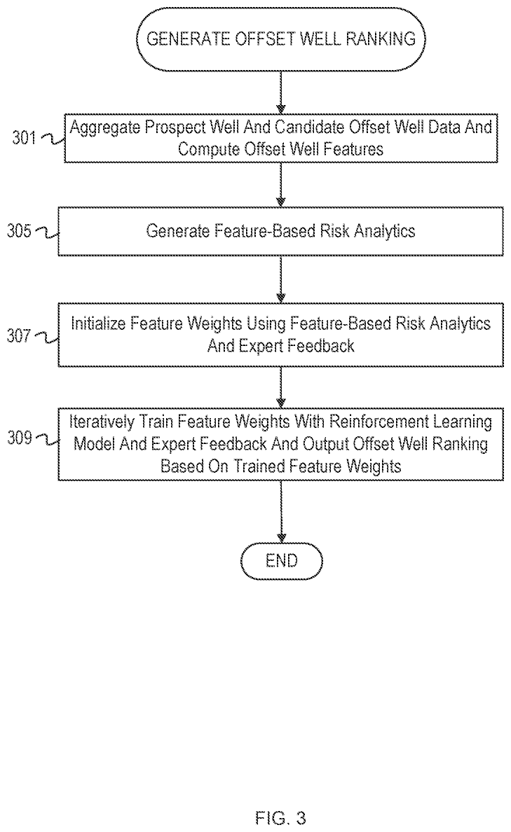

FIG. 3 is a flowchart of example operations for generating a candidate offset well ranking. Operations are described with reference to a data filter, a feature generator, a risk analytics engine, an RL model, and an expert. Naming or labeling of programs can be arbitrary, as well as modular organization of a program.

At block 301, the data filter aggregates prospect well data and candidate offset well data. Depending on the stage of design for the casing schema of a prospect well, the data can correspond to all sections of the offset wells or specific well sections. The data filter sorts offset well data by feature as described variously above. The feature generator computes offset well features using filtered well data. Similarity features can be generated by data preprocessing and a combination of models and straightforward computations as described previously.

At block 303, the risk analytics engine generates feature-based risk analytics. The feature-based risk analytics are generated in two phases. First, the risk analytics engine receives NPT, cost per foot, and time to drill a specified distance data filtered from the candidate offset well data and prospect well data that have been aggregated and outputs a set of hazards identified in the data and associated severity metrics. The risk analytics engine identifies features associated with a set of hazards based on this output having high severity metric. For instance, a candidate offset well can have a particularly high time to drill 10,000 feet, indicating potentially hazardous drilling conditions. The risk analytics engine can identify this hazard and can convey the risk severity associated with the time to drill 10,000 feet severity metric to the RL model.

At block 305, the RL model initializes a set of feature weights using the feature-based risk analytics and expert feedback. In some embodiments, the expert can initialize the set of feature weights. Alternatively, the RL model can initialize the feature weights randomly, can skew features associated with high risk severity to have higher weights, and can add randomness or skew to expert initialized feature weights.

At block 307, feature weights are initialized using feature-based risk analytics. The feature weights can also be initialized using domain knowledge of importance for certain features during prospect well design (e.g., expert feedback). For example, a feature associated with hazards that have a high severity metric as determined at block 303 can be assigned a higher weight because this feature has a greater impact on safety for the prospect well design.

At block 309, the RL model iteratively trains feature weight using expert feedback. For instance, feature weight training may begin with a feedback loop where the expert generates a set of feature weights, the RL model gives a candidate offset well ranking based on the set of feature weights, and the expert updates the set of feature weights based on the quality of the candidate offset well ranking. The RL model can train on the quality of the received candidate offset well rankings from the expert as well as the sets of feature weights, as described variously above. Once the RL model has received enough training data so that a training end condition such as an internal convergence threshold has been reached, the RL model begins generating feature weights and candidate offset well rankings. The expert receives the feature weights and a candidate offset well ranking and returns a quality of the candidate offset well ranking. Training continues with this version of expert/RL model feedback until a different training end condition is reached. Once training is complete, a candidate offset well ranking based on a trained set of feature weights is returned. Each of the iterations described above can be implemented in isolation, and other RL model/expert feedback loops can be implemented.

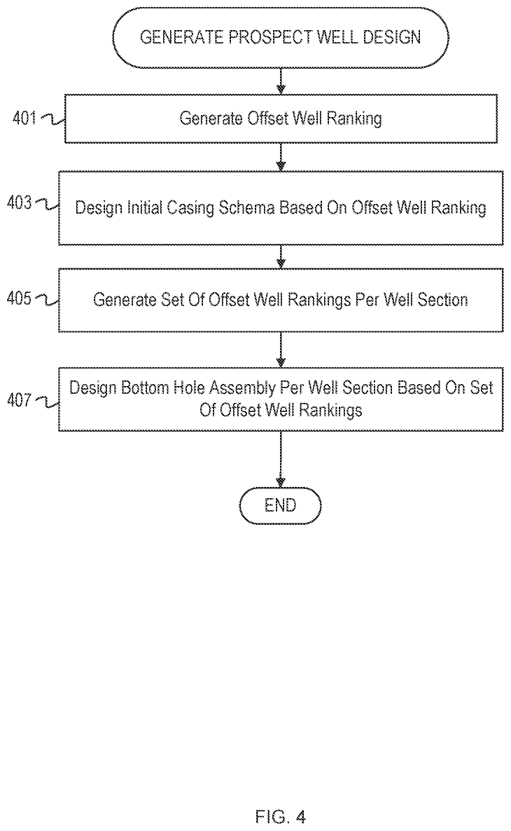

FIG. 4 is a flowchart of example operations for generating a prospect well casing schema. The description of FIG. 4 refers to an automated offset well analytics engine as performing example operations for consistency with the earlier description. Naming or labeling of programs can be arbitrary, as well as modular organization of a program.

At block 401, the automated offset well analytics engine generates a ranking of the candidate template offset wells. The automated offset well analytics engine generates the ranking based on an aggregation of data from data sources corresponding to the candidate offset wells and a specified scoping parameter. The scoping parameter specifies a scope of candidate template offset wells to be used to design a casing schema for a prospect well. The automated offset well analytics engine can obtain the scoping parameter or indication of scope from a file or via a user interface. The offset well analytics engine aggregates data across data sources corresponding to the received scope and generates a ranking of candidate template offset wells. The data aggregated comprises well data for all sections of the offset wells, up to a depth threshold corresponding to the planned depth of the prospect well. The scope specified by the user can limit or expand the hole size, types of casing material, etc. used in candidate template offset wells.

At block 403, the automated offset well analytics engine designs an initial casing schema using the ranked candidate template offset wells. The offset well analytics engine can implement a combination of casing design elements from multiple candidate template offset wells. These casing design elements inform design choices including depth of particular casings in the prospect well and depth of various components of a drilling system, as well as a hole size for each casing section at the corresponding depths. The chosen casing schema is verified against pore pressure and fracture pressure envelopes for the prospect well.

At block 405, offset well analytics engine generates a per section ranking of the candidate template offset wells. The offset well analytics engine obtains a set of scopes, each scope corresponding to a section of the prospect well. The set of scopes may be inputs into the offset well analytics engine. The scopes can specify well sections of the prospect well that display anomalous behavior such as tight bending in well trajectory, hazardous well conditions, etc.

At block 407, the automated offset well analytics engine designs a bottom hole assembly as well as various other operational considerations for each well section based on the set of offset well rankings. Operational considerations can include drill pipe type, drill bit type, drilling mud programs, pump rates, rotation speeds, etc. All operational specifics are determined with respect to offset well rankings for the respective well section as well as offset well designs for the respective section. The automated offset well analytics engine can extract the relevant operational data from various data sources for the ranked offset wells during the well design process.

The operations depicted in FIG. 4 are described with reference to a user making design choices specific to a prospect well and template offset wells. Any of the example operations can be performed by the automated offset well analytics engine. Any resulting prospect well design can be verified and/or calibrated by a user before drilling system deployment at the prospect well.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

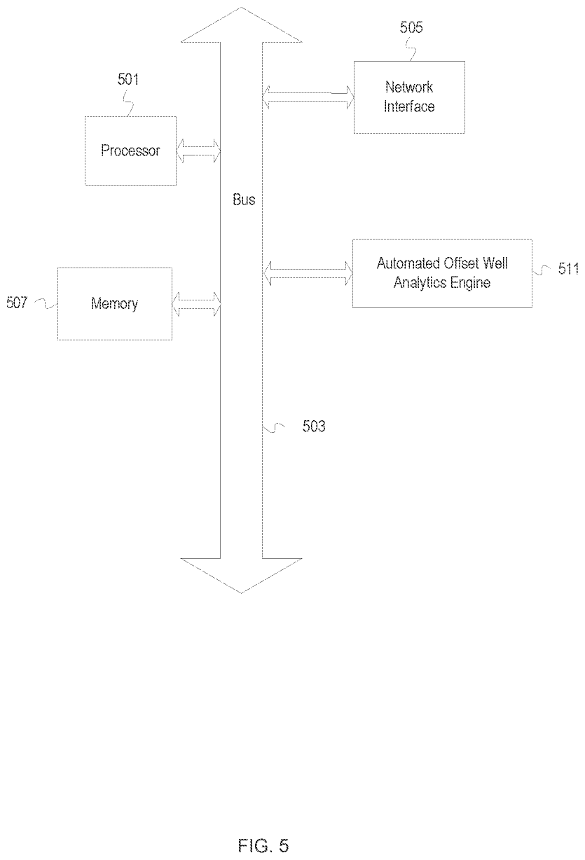

FIG. 5 depicts an example computer system with an automated offset well analytics engine. The computer system includes a processor unit 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes an automated offset well analytics engine 511. The automated offset well analytics engine 511 can automatically generate template offset well rankings as described above. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5. The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for offset well analysis as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

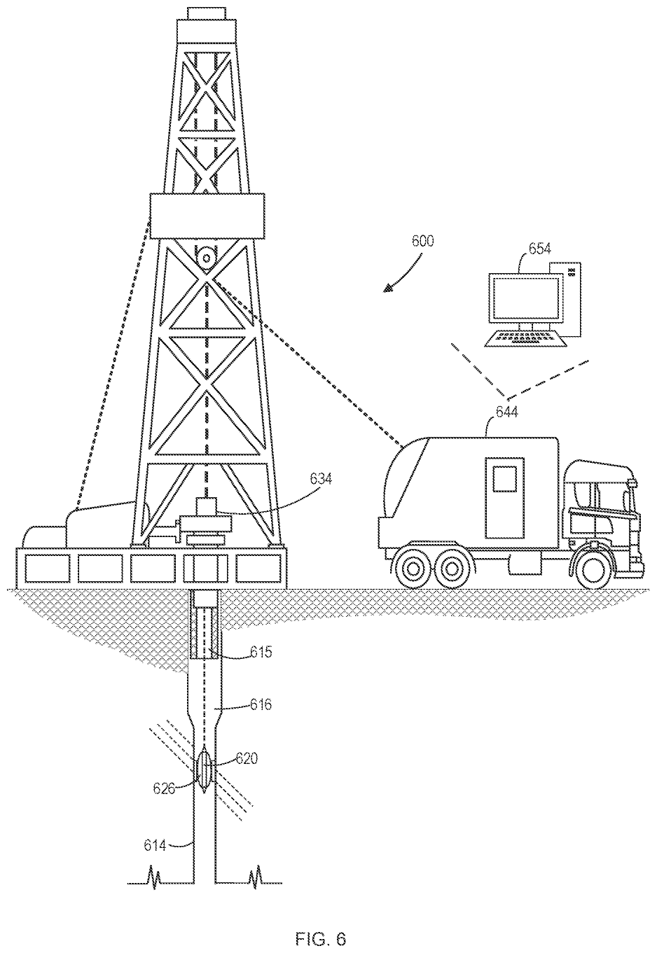

FIG. 6 depicts a system diagram of a wireline system with an automated offset well analytics engine. A system 600 can be used in an illustrative logging environment with a drillstring removed, in accordance with some embodiments of the present disclosure.

Subterranean operations may be conducted using a wireline system 620 once the drillstring has been removed, though, at times, some or all of the drillstring may remain in a borehole 614 during logging with the wireline system 620. The wireline system 620 may include one or more logging tools 626 that may be suspended in the borehole 614 by a conveyance 615 (e.g., a cable, slickline, or coiled tubing). The logging tool 626 may be communicatively coupled to the conveyance 615. The conveyance 615 may contain conductors for transporting power to the wireline system 620 and telemetry from the logging tool 626 to a logging facility 644. The logging facility 644 comprises an automated offset well analytics engine 654 that can rank candidate template offset wells using features as described variously above. Alternatively, the conveyance 615 may lack a conductor, as is often the case using slickline or coiled tubing, and the wireline system 620 may contain a control unit 634 that contains memory, one or more batteries, and/or one or more processors for performing operations and storing measurements.

In certain embodiments, the control unit 634 can be positioned at the surface, in the borehole (e.g., in the conveyance 615 and/or as part of the logging tool 626) or both (e.g., a portion of the processing may occur downhole and a portion may occur at the surface). The control unit 634 may include a control system or a control algorithm. In certain embodiments, a control system, an algorithm, or a set of machine-readable instructions may cause the control unit 634 to generate and provide an input signal to one or more elements of the logging tool 626, such as the sensors along the logging tool 626. The input signal may cause the sensors to be active or to output signals indicative of sensed properties. The logging facility 644 (shown in FIG. 6 as a truck, although it may be any other structure) may collect measurements from the logging tool 626, and may include computing facilities for controlling, processing, or storing the measurements gathered by the logging tool 626. The computing facilities may be communicatively coupled to the logging tool 626 by way of the conveyance 615 and may operate similarly to the control unit 634. In certain example embodiments, the control unit 634, which may be located in logging tool 626, may perform one or more functions of the computing facility.

The logging tool 626 includes a mandrel and a number of extendible arms coupled to the mandrel. One or more pads are coupled to each of the extendible arms. Each of the pads have a surface facing radially outward from the mandrel. Additionally, at least sensor disposed on the surface of each pad. During operation, the extendible arms are extended outwards to a wall of the borehole to extend the surface of the pads outward against the wall of the borehole. The sensors of the pads of each extendible arm can detect image data to create captured images of the formation surrounding the borehole.

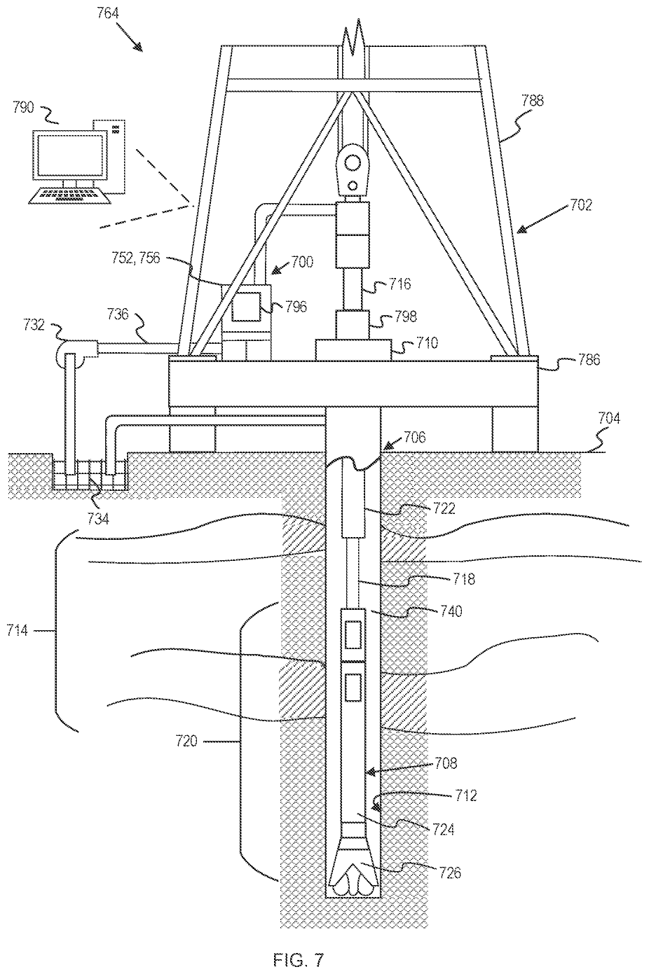

FIG. 7 depicts a system diagram of a drilling rig system with an automated offset well analytics engine. For example, in FIG. 7 it can be seen how a system 764 may also form a portion of a drilling rig 702 located at the surface 704 of a well 706. Drilling of oil and gas wells is commonly carried out using a string of drill pipes connected together so as to form a drilling string 708 that is lowered through a rotary table 710 into a wellbore or borehole 712. Here a drilling platform 786 is equipped with a derrick 788 that supports a hoist. A reservoir modeling system with distributed computing 790 can be communicatively coupled to any measurements devices attached to the system 764 and can efficiently model a reservoir by decomposing the reservoir model into tiles and running sub models on each tile as described variously above.

The drilling rig 702 may thus provide support for the drill string 708. The drill string 708 may operate to penetrate the rotary table 710 for drilling the borehole 712 through subsurface formations 714. The drill string 708 may include a Kelly 716, drill pipe 718, and a bottom hole assembly 720, perhaps located at the lower portion of the drill pipe 718.

The bottom hole assembly 720 may include drill collars 722, a down hole tool 724, and a drill bit 726. The drill bit 726 may operate to create a borehole 712 by penetrating the surface 704 and subsurface formations 714. The down hole tool 724 may comprise any of a number of different types of tools including MWD tools, LWD tools, and others.

During drilling operations, the drill string 708 (perhaps including the Kelly 716, the drill pipe 718, and the bottom hole assembly 720) may be rotated by the rotary table 710. In addition to, or alternatively, the bottom hole assembly 720 may also be rotated by a motor (e.g., a mud motor) that is located down hole. The drill collars 722 may be used to add weight to the drill bit 726. The drill collars 722 may also operate to stiffen the bottom hole assembly 720, allowing the bottom hole assembly 720 to transfer the added weight to the drill bit 726, and in turn, to assist the drill bit 726 in penetrating the surface 704 and subsurface formations 714.

During drilling operations, a mud pump 732 may pump drilling fluid (sometimes known by those of ordinary skill in the art as “drilling mud”) from a mud pit 734 through a hose 736 into the drill pipe 718 and down to the drill bit 726. The drilling fluid can flow out from the drill bit 726 and be returned to the surface 704 through an annular area 740 between the drill pipe 718 and the sides of the borehole 712. The drilling fluid may then be returned to the mud pit 734, where such fluid is filtered. In some embodiments, the drilling fluid can be used to cool the drill bit 726, as well as to provide lubrication for the drill bit 726 during drilling operations. Additionally, the drilling fluid may be used to remove subsurface formation 714 cuttings created by operating the drill bit 726. It is the images of these cuttings that many embodiments operate to acquire and process.

Terminology

This description uses shorthand terms related to cloud technology for efficiency and ease of explanation. When referring to “a cloud,” this description is referring to the resources of a cloud service provider. For instance, a cloud can encompass the servers, virtual machines, and storage devices of a cloud service provider.

As used herein, the term “or” is inclusive unless otherwise explicitly noted. Thus, the phrase “at least one of A, B, or C” is satisfied by any element from the set {A, B, C} or any combination thereof, including multiples of any element.

### Example Embodiments

Example embodiments can include the following:

Embodiment 1: A method comprising determining well features from data of a prospect well and data of candidate offset wells, comparing data of the prospect well with data of each of the candidate offset wells to determine well similarity features, initializing first feature weights for well features of the candidate offset wells and second feature weights for the well similarity features, inputting well features of the candidate offset wells, the well similarity features, first feature weights for the well features, and second feature weights for the well similarity features into a reinforcement learning model to generate a candidate offset well similarity ranking, updating the first and second features weights to generate updated first feature weights and updated second feature weights based, at least in part, on the candidate offset well similarity ranking, and inputting the updated first and second feature weights into the reinforcement learning model to generate an updated candidate offset well similarity ranking.

Embodiment 2: The method of embodiment 1, further comprising generating an indicator of quality for the candidate offset well similarity ranking, and inputting the indicator of quality into the reinforcement learning model as well as the first and second feature weights to generate the updated candidate offset well similarity ranking.

Embodiment 3: The method of any of embodiments 1-2, further comprising updating the reinforcement learning model based on the first and second feature weights and the updated first and second feature weights.

Embodiment 4: The method of any of embodiments 1-3, wherein the well features and the well similarity features comprise risk features that indicate a level of risk for prospect well design.

Embodiment 5: The method of embodiment 4, wherein the risk features are determined based, at least in part, on natural language processing of text well data in the data of the prospect well and the data of the candidate offset wells.

Embodiment 6: The method of embodiment 4, wherein initializing feature weights for the risk features comprises initializing feature weights based, at least in part, on levels of risk for the prospect well indicated in the risk features.

Embodiment 7: The method of any of embodiments 1-6, further comprising designing the prospect well based on the updated candidate offset well similarity ranking.

Embodiment 8: A non-transitory, computer-readable medium having instructions stored thereon that are executable by a computing device to perform operations comprising determining well features from data of a prospect well and data of candidate offset wells, comparing data of the prospect well with data of each of the candidate offset wells to determine well similarity features, initializing first feature weights for well features of the candidate offset wells and second feature weights for the well similarity features wherein initializing the first feature weights and second feature weights comprises initializing the first feature weights and second feature weights based, at least in part, on known importance for the well features and the well similarity features for prospect well design, inputting the well features, the well similarity features, and the first and second feature weights into a reinforcement learning model to generate a candidate offset well similarity ranking, updating the first and second features weights to generate updated first feature weights and updated second feature weights based, at least in part, on the candidate offset well similarity ranking, and inputting the updated first and second feature weights into the reinforcement learning model to generate an updated candidate offset well similarity ranking.

Embodiment 9: The non-transitory, computer-readable medium of embodiment 8, further comprising instructions executable by the computing device to generate an indicator of quality for the candidate offset well similarity ranking, and input the indicator of quality into the reinforcement learning model as well as the first and second feature weights to generate the updated candidate offset well similarity ranking.

Embodiment 10: The non-transitory computer-readable medium of any of embodiments 8-9, further comprising instructions executable by the computing device to update the reinforcement learning model based on the first and second feature weights and the updated first and second feature weights.

Embodiment 11: The non-transitory computer-readable medium of any of embodiments 8-10, wherein the well features and the well similarity features comprise risk features that indicate a level of risk for prospect well design.

Embodiment 12: The non-transitory computer-readable medium of embodiment 11, wherein the instructions executable by the computing device to determine risk features comprise instructions to determine risk features based, at least in part, on natural language processing of text well data in the data of the prospect well and the data of the candidate offset wells.

Embodiment 13: The non-transitory computer-readable medium of embodiment 11, wherein the instructions executable by the computing device to initialize feature weights for the risk features comprise instructions to initialize feature weights based, at least in part, on levels of risk for the prospect well indicated in the risk features.

Embodiment 14: The non-transitory computer-readable medium of any of embodiments 8-13, further comprising instructions executable by the computing device to design the prospect well based on the updated candidate offset well similarity ranking.

Embodiment 15: An apparatus comprising a processor, and a computer-readable medium having instructions stored thereon that are executable by the processor to cause the apparatus to, determine well features from data of a prospect well and data of candidate offset wells, compare data of the prospect well with data of each of the candidate offset wells to determine well similarity features, initialize first feature weights for well features of the candidate offset wells and second feature weights for the well similarity features wherein initializing the first feature weights and second feature weights comprises initializing the first feature weights and second feature weights based, at least in part, on known importance for the well features and the well similarity features for prospect well design, input the well features, the well similarity features, and the first and second feature weights into a reinforcement learning model to generate a candidate offset well similarity ranking, update the first and second features weights to generate updated first feature weights and updated second feature weights based, at least in part, on the candidate offset well similarity ranking, and input the updated first and second feature weights into the reinforcement learning model to generate an updated candidate offset well similarity ranking.

Embodiment 16: The apparatus of embodiment 15, further comprising instructions executable by the processor to cause the apparatus to generate an indicator of quality for the candidate offset well similarity ranking, and input the indicator of quality into the reinforcement learning model as well as the first and second feature weights to generate the updated candidate offset well similarity ranking

Embodiment 17: The apparatus of any of embodiments 15-16, further comprising instructions executable by the processor to cause the apparatus to update the reinforcement learning model based on the first and second feature weights and the updated first and second feature weights.

Embodiment 18: The apparatus of any of embodiments 15-17, wherein the well features and the well similarity features comprise risk features that indicate a level of risk for prospect well design.

Embodiment 19: The apparatus of embodiment 18, wherein the instructions executable by the processor to cause the apparatus to determine risk features comprise instructions to determine risk features based, at least in part, on natural language processing of text well data in the data of the prospect well and the data of the candidate offset wells.

Embodiment 20: The apparatus of any of embodiments 15-19, further comprising instructions executable by the processor to cause the apparatus to design the prospect well based on the updated candidate offset well similarity ranking.

What is claimed is:

1. A method comprising:
determining well features from data of a prospect well and data of candidate offset wells;
comparing data of the prospect well with data of each of the candidate offset wells to determine well similarity features;
initializing first feature weights for well features of the candidate offset wells and second feature weights for the well similarity features;
inputting well features of the candidate offset wells, the well similarity features, first feature weights for the well features, and second feature weights for the well similarity features into a reinforcement learning model to generate a candidate offset well similarity ranking;
updating the first and second features weights to generate updated first feature weights and updated second feature weights based, at least in part, on the candidate offset well similarity ranking; and
inputting the updated first and second feature weights into the reinforcement learning model to generate an updated candidate offset well similarity ranking.

2. The method of claim 1 further comprising:
generating an indicator of quality for the candidate offset well similarity ranking; and
inputting the indicator of quality into the reinforcement learning model as well as the first and second feature weights to generate the updated candidate offset well similarity ranking.

3. The method of claim 1, further comprising updating the reinforcement learning model based on the first and second feature weights and the updated first and second feature weights.

4. The method of claim 1, wherein the well features and the well similarity features comprise risk features that indicate a level of risk for prospect well design.

5. The method of claim 4, wherein the risk features are determined based, at least in part, on natural language processing of text well data in the data of the prospect well and the data of the candidate offset wells.

6. The method of claim 4, wherein initializing feature weights for the risk features comprises initializing feature weights based, at least in part, on levels of risk for the prospect well indicated in the risk features.

7. The method of claim 1, further comprising designing the prospect well based on the updated candidate offset well similarity ranking.

8. A non-transitory, computer-readable medium having instructions stored thereon that are executable by a computing device to perform operations comprising:
determining well features from data of a prospect well and data of candidate offset wells;
comparing data of the prospect well with data of each of the candidate offset wells to determine well similarity features;
initializing first feature weights for well features of the candidate offset wells and second feature weights for the well similarity features wherein initializing the first feature weights and second feature weights comprises initializing the first feature weights and second feature weights based, at least in part, on known importance for the well features and the well similarity features for prospect well design;
inputting the well features, the well similarity features, and the first and second feature weights into a reinforcement learning model to generate a candidate offset well similarity ranking;
updating the first and second features weights to generate updated first feature weights and updated second feature weights based, at least in part, on the candidate offset well similarity ranking; and
inputting the updated first and second feature weights into the reinforcement learning model to generate an updated candidate offset well similarity ranking.

9. The computer-readable medium of claim 8 further comprising instructions executable by the computing device to:
generate an indicator of quality for the candidate offset well similarity ranking; and
input the indicator of quality into the reinforcement learning model as well as the first and second feature weights to generate the updated candidate offset well similarity ranking.

10. The computer-readable medium of claim 8, further comprising instructions executable by the computing device to update the reinforcement learning model based on the first and second feature weights and the updated first and second feature weights.

11. The computer-readable medium of claim 8, wherein the well features and the well similarity features comprise risk features that indicate a level of risk for prospect well design.

12. The computer-readable medium of claim 11, wherein the instructions executable by the computing device to determine risk features comprise instructions to determine risk features based, at least in part, on natural language processing of text well data in the data of the prospect well and the data of the candidate offset wells.

13. The computer-readable medium of claim 11, wherein the instructions executable by the computing device to initialize feature weights for the risk features comprise instructions to initialize feature weights based, at least in part, on levels of risk for the prospect well indicated in the risk features.

14. The computer-readable medium of claim 8, further comprising instructions executable by the computing device to design the prospect well based on the updated candidate offset well similarity ranking.

15. An apparatus comprising:
a processor; and
a computer-readable medium having instructions stored thereon that are executable by the processor to cause the apparatus to,
determine well features from data of a prospect well and data of candidate offset wells;
compare data of the prospect well with data of each of the candidate offset wells to determine well similarity features;
initialize first feature weights for well features of the candidate offset wells and second feature weights for the well similarity features wherein initializing the first feature weights and second feature weights comprises initializing the first feature weights and second feature weights based, at least in part, on known importance for the well features and the well similarity features for prospect well design;
input the well features, the well similarity features, and the first and second feature weights into a reinforcement learning model to generate a candidate offset well similarity ranking;
update the first and second features weights to generate updated first feature weights and updated second feature weights based, at least in part, on the candidate offset well similarity ranking; and
input the updated first and second feature weights into the reinforcement learning model to generate an updated candidate offset well similarity ranking.

16. The apparatus of claim 15 further comprising instructions executable by the processor to cause the apparatus to:
generate an indicator of quality for the candidate offset well similarity ranking; and
input the indicator of quality into the reinforcement learning model as well as the first and second feature weights to generate the updated candidate offset well similarity ranking.

17. The apparatus of claim 15, further comprising instructions executable by the processor to cause the apparatus to update the reinforcement learning model based on the first and second feature weights and the updated first and second feature weights.

18. The apparatus of claim 15, wherein the well features and the well similarity features comprise risk features that indicate a level of risk for prospect well design.

19. The apparatus of claim 18, wherein the instructions executable by the processor to cause the apparatus to determine risk features comprise instructions to determine risk features based, at least in part, on natural language processing of text well data in the data of the prospect well and the data of the candidate offset wells.

20. The apparatus of claim 15, further comprising instructions executable by the processor to cause the apparatus to design the prospect well based on the updated candidate offset well similarity ranking.
